(19) United States
(12) Patent Application Publication
(10) Pub. No.: US 2008/0046146 A1
(43) Pub. Date: Feb. 21, 2008

(54) System and Method for Automatic Air Conditioning/Heating Venting Control Detection for Vehicles

(76) Inventors: Bobbi A. Brekke, Austin, TX (US); Michelle R. Cereceres, Austin, TX (US); Francisco Garcia, Manor, TX (US); Wendy S. Korn, Austin, TX (US); David Nevarez, Austin, TX (US); Debora Velarde, Beaverton, OR (US); Marcos A. Villarreal, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/460,869

(22) Filed: Jul. 28, 2006

(51) Int. Cl. E05F 15/00

(52) U.S. Cl. 701/45

(57) ABSTRACT

A method, system, and computer-usable medium for automatic air conditioning/heating venting control detection for vehicles. According to a preferred embodiment of the present invention, a vent control manager monitors a seat in a vehicle to determine if a passenger is occupying the seat and in response to determining the seat is occupied, the vent control manager opens at least one vent facing the seat. In response to determining the seat is not occupied, the vent control manager closes at least one vent facing the seat.

### BACKGROUND OF THE INVENTION

1. Technical Field

The present invention relates in general to the field of temperature regulation. Still more particularly, the present invention relates to a system and method for automatic air conditioning/heating venting control detection for vehicles.

2. Description of the Related Art

While some vehicles provide automatic thermostat-like cooling/heating temperature regulation, the ability to control the airflow is still manually controlled. Vents are located throughout the vehicle, each placed to cool/warm the seated passengers. If the vent is open, air flows through. If not, the air is blocked and redirected to other open vents. For this reason, the driver may close vents throughout the vehicle to cause more air to be redirected towards the driver. However, the driver may not be able to easily reach the other vents to manually close them while driving. Also, if the driver normally keeps many of the vents closed, passengers will have to manually open their respective vents in order for air to flow through the formally-closed vents. Therefore, there is a need for a system and method for addressing the aforementioned limitations of the prior art.

### SUMMARY OF THE INVENTION

The present invention includes a method, system, and computer-usable medium for automatic air conditioning/heating venting control detection for vehicles. According to a preferred embodiment of the present invention, a vent control manager monitors a seat in a vehicle to determine if a passenger is occupying the seat and in response to determining the seat is occupied, the vent control manager opens at least one vent facing the seat. In response to determining the seat is not occupied, the vent control manager closes at least one vent facing the seat.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1A is a block diagram illustrating an exemplary data processing system in which a preferred embodiment of the present invention may be implemented;

FIG. 1B is a pictorial representation depicting an exemplary vehicle dashboard in which a preferred embodiment of the present invention may be implemented; and

FIG. 2 is a high-level logical flowchart diagram illustrating an exemplary method for automatic air conditioning/heating venting control detection for vehicles according to a preferred embodiment of the present invention.

### DETAILED DESCRIPTION OF A PREFERRED EMBODIMENT

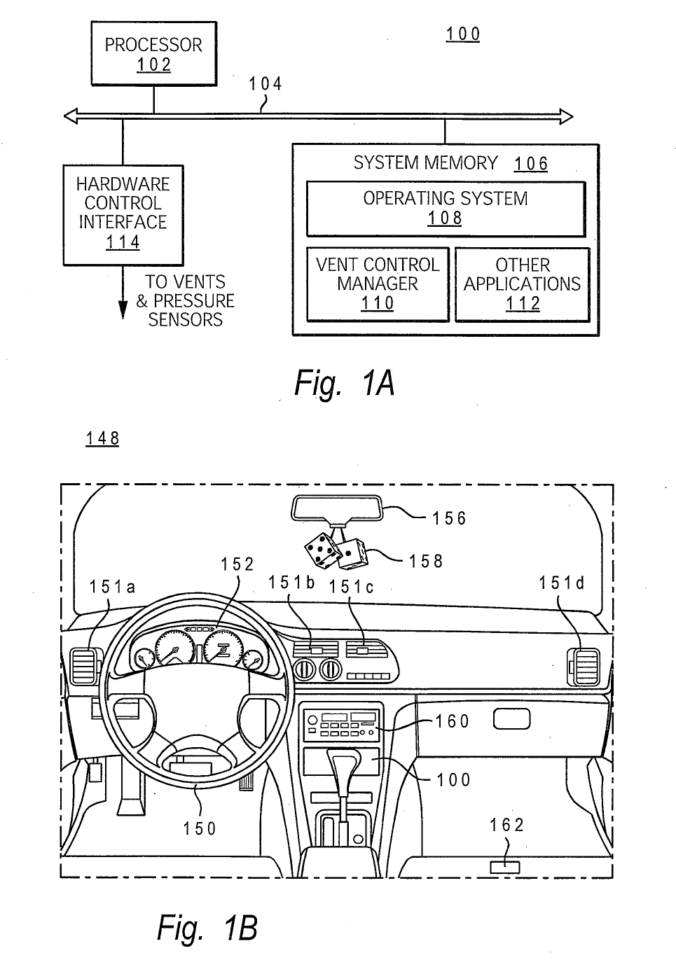

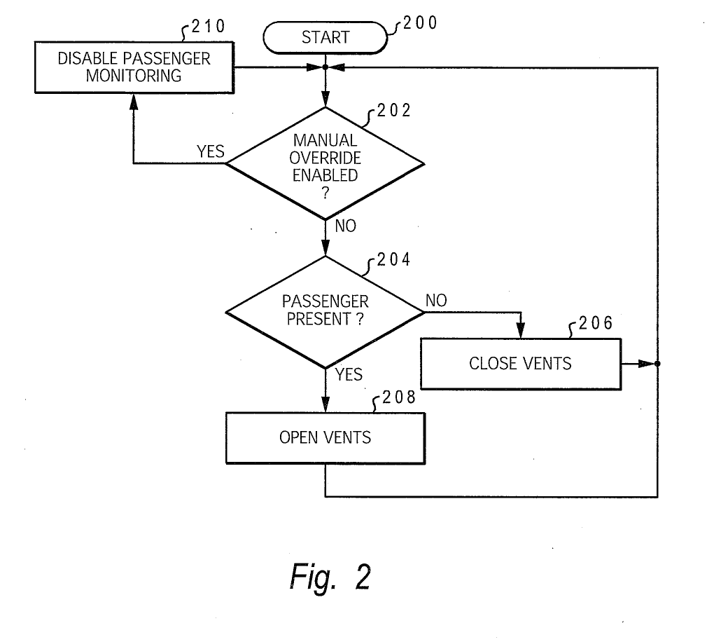

Referring now to the figures, and in particular, referring to FIG. 1A, there is illustrated a block diagram depicting an exemplary data processing system 100 in which a preferred embodiment of the present invention may be implemented. As illustrated, data processing system 100 includes a processor 102, system memory 106, and a hardware control interface 114, all coupled by an interconnect 104. System memory 106 includes an operating system 108, vent control manager 110, and other applications 112. In a preferred embodiment of the present invention, vent control manager 110 via hardware control interface 114 and pressure sensor 162 detects changes in the occupancy of a vehicle. In response to detecting the absence or presence of a passenger via pressure sensor 162, vent control manager 110 controls the opening or closing vents 114a-d, as discussed herein in more detail in conjunction with FIG. 2.

Those skilled in the art will appreciate that data processing system 100 can include many additional components not specifically illustrated in FIG. 1. Because such additional components are not necessary for an understanding of the present invention, they are not illustrated in FIG. 1 or discussed further herein. It should also be understood, however, that the enhancements to data processing system 100 for automatic air conditioning/heating venting control detection for vehicles provided by the present invention are applicable to data processing systems of any system architecture and are in no way limited to the generalized single processor architecture illustrated in FIG. 2.

FIG. 1B is a pictorial representation depicting an exemplary vehicle dashboard 148 in which a preferred embodiment of the present invention may be implemented. As illustrated, vehicle dashboard 148 includes steering wheel 150, instrument panel 152, vents 151a-d, rearview mirror 156, personalization accessory 158, radio 160, and pressure sensor 162.

In a preferred embodiment of the present invention, pressure sensor 162 and vents 151a-d are coupled to data processing system 100 via hardware control interface 114, which control the opening/closing of vents 151a-d in response to data received from pressure sensor 162. Pressure sensor 162 is preferably implemented within a passenger seat. Also, as depicted, personalization accessory 158 is preferably hung from rearview mirror 156. While personalization accessory 158 is depicted as a pair of fuzzy dice, those with skill in the art will appreciate that personalization accessory 158 may be implemented by any object, including but not limited to: Mardi Gras beads, pine-tree shaped air fresheners, and high school graduation tassels.

FIG. 2 is a high-level logical flowchart diagram illustrating an exemplary method for automatic air conditioning/heating venting control detection for vehicles according to a preferred embodiment of the present invention. The process begins at step 200 and proceeds to step 202, which illustrates vent control manager 110 determining if a manual override has been selected by the driver. In a preferred embodiment of the present invention, the driver or operator can disable the vent control system, if needed. One situation where the manual override may be desired is if miscellaneous cargo inside the vehicle provides enough weight that vent control manager 110 determines that a passenger is present in a particular seat. If the manual override is enabled, the process proceeds to step 210, which illustrates vent control manager 110 disabling passenger monitoring. The process returns to step 202 and proceeds in an iterative fashion.

Returning to step 202, if vent control manager 110 determines that the manual override is disabled, the process continues to step 204, which illustrates vent control manager 110 determining via hardware control interface 114 and pressure sensor 162 if a passenger is present in a particular seat. In a preferred embodiment of the present invention, vent control manager 110 may have a weight or pressure limit to determine if a passenger is present. For example, if the pressure detected by pressure sensor 162 equals or exceeds 30 lbs, vent control manager 110 may conclude that a passenger is present in the seat. Of course, those with skill in the art will appreciate that the pressure threshold utilized by vent control manager 110 to determine whether a passenger is present may be set to any pressure and is not limited to 30 lbs.

If vent control manager 110 determines that a passenger is not present, the process continues to step 206, which illustrates vent control manager 110 sending a command to close vents 151a-d via hardware control interface 114. The process returns to step 202 and proceeds in an iterative fashion.

If vent control manager 110 determines that a passenger is present, the process continues to step 208, which illustrates vent control manager 110 sending a command to open vents 151a-d via hardware control interface 114. The process returns to step 202 and proceeds in an iterative fashion.

As discussed, the present invention includes a method, system, and computer-usable medium for automatic air conditioning/heating venting control detection for vehicles. According to a preferred embodiment of the present invention, a vent control manager monitors a seat in a vehicle to determine if a passenger is occupying the seat and in response to determining the seat is occupied, the vent control manager opens at least one vent facing the seat. In response to determining the seat is not occupied, the vent control manager closes at least one vent facing the seat.

It should be understood that at least some aspects of the present invention may alternatively be implemented in a computer-usable medium that contains a program product. Programs defining functions in the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory, such as, but not limited to Random Access Memory (RAM), and communication media, such as computer and telephone networks including Ethernet, the Internet, wireless networks, and like network systems. It should be understood, therefore, that such signal-bearing media, when carrying or encoding computer-readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention. Furthermore, as utilized in the specification and the appended claims, the term “computer” or “system” or “computer system” or “computing device” includes any data processing system including, but not limited to, personal computers, servers, workstations, network computers, mainframe computers, routers, switches, personal digital assistants (PDAs), telephones, and any other system capable of processing, transmitting, receiving, capturing, and/or storing data.

1. A computer-implementable method for implementing automatic air conditioning/heating venting control for a vehicle, said computer-implementable method comprising:
implementing a vent control manager within a system memory of a data processing system, wherein said data processing system is located within a dashboard of said vehicle, and wherein said dashboard further includes a personalization accessory for providing an aesthetically pleasing driving environment for at least one passenger in said vehicle;
coupling said vent control manager to at least one vent and at least one pressure sensor via a hardware control interface, wherein said at least one pressure sensor is located within at least one passenger seat within said vehicle;
monitoring with said vent control manager at least one passenger seat in said vehicle to determine if a passenger is occupying said at least one passenger seat by measuring pressure applied to said at least one passenger seat with said at least one pressure sensor;
determining if said at least one passenger seat is occupied by comparing said measured pressure applied to said at least one passenger seat to a predetermined pressure tbreshold; and
in response to determining said seat is occupied, opening at least one vent facing said seat.

2. The computer-implementable method according to claim 1, further comprising:
determining if a manual override is enabled; and
in response to determining said manual override is enabled, suspending said monitoring.

3. The computer-implementable method according to claim 1, further comprising:
in response to determining said seat is not occupied, closing at least one vent facing said seat.

4. A system comprising:
a processor;
a data bus coupled to said processor; and
a computer-usable medium embodying computer-program code, said computer-usable medium being coupled to said data bus, said computer program code comprising instructions executable by said processor and configured for:
implementing a vent control manager within a system memory of a data processing system, wherein said data processing system is located within a dashboard of said vehicle, and wherein said dashboard further includes a personalization accessory for providing an aesthetically pleasing driving environment for at least one passenger in said vehicle;
coupling said vent control manager to at least one vent and at least one pressure sensor via a hardware control interface, wherein said at least one pressure sensor is located within at least one passenger seat within said vehicle;
monitoring with said vent control manager at least one passenger seat in said vehicle to determine if a passenger is occupying said at least one passenger seat by measuring pressure applied to said at least one passenger seat with said at least one pressure sensor; and
determining if said at least one passenger seat is occupied by comparing said measured pressure applied to said at least one passenger seat to a predetermined pressure threshold; and
in response to determining said seat is occupied, opening at least one vent facing said seat.

5. The system according to claim 4, wherein said instructions are further configured for:
determining if a manual override is enabled; and
in response to determining said manual override is enabled, suspending said monitoring.

6. The system according to claim 4, wherein said instructions are further configured for:
in response to determining said seat is not occupied, closing at least one vent facing said seat.

7. A computer-usable medium embodying computer program code, said computer program code comprising computer-executable instructions configured for:
implementing a vent control manager within a system memory of a data processing system, wherein said data processing system is located within a dashboard of said vehicle, and wherein said dashboard further includes a personalization accessory for providing an aesthetically pleasing driving environment for at least one passenger in said vehicle;
coupling said vent control manager to at least one vent and at least one pressure sensor via a hardware control interface, wherein said at least one pressure sensor is located within at least one passenger seat within said vehicle;
monitoring with said vent control manager at least one passenger seat in said vehicle to determine if a passenger is occupying said at least one passenger seat by measuring pressure applied to said at least one passenger seat with said at least one pressure sensor; and
determining if said at least one passenger seat is occupied by comparing said measured pressure applied to said at least one passenger seat to a predetermined pressure threshold: and
in response to determining said seat is occupied, opening at least one vent facing said seat.

8. The computer-usable medium according to claim 7, wherein said embodied computer program code further comprises computer-executable instructions configured for:
determining if a manual override is enabled; and
in response to determining said manual override is enabled, suspending said monitoring.

9. The computer-usable medium according to claim 7, wherein said embodied compute program code further comprises computer-executable instructions configured for:
in response to determining said seat is not occupied, closing at least one vent facing said seat.
